(19) United States
(12) Patent Application Publication
(10) Pub. No.: US 2026/0187345 A1
(43) Pub. Date: Jul. 2, 2026

(54) AUTOMATED INSIGHTS IN NOTE APPLICATIONS

(71) Applicant: Microsoft Technology Licensing, LLC, Redmond, WA (US)

(72) Inventors: David J. CONGER, Issaquah, WA (US); Iman Abdullahi YUSUF, Seattle, WA (US); Viktoryia AKULICH, Kirkland, WA (US)

(73) Assignee: Microsoft Technology Licensing, LLC, Redmond, WA (US)

(21) Appl. No.: 19/003,621

(22) Filed: Dec. 27, 2024

(51) Int. Cl. G06F 40/166

(52) U.S. Cl. CPC G06F 40/166

(57) ABSTRACT

Implementations for providing automated insights in note applications are provided. One example includes a computing system for providing automated insights in a note application, the computing system comprising: processing circuitry and memory storing instructions that, during execution, causes the processing circuitry to: analyze content of a note in real-time in the note application using a large language model (LLM), wherein the LLM identifies content search query with retrieval-augmented generation (RAG) in a database; retrieve content from the database; summarize the retrieved content from the database using the LLM; display the summarized retrieved content in real-time in the note application; and upon receiving input from a user to incorporate the summarized retrieved content, incorporate the summarized retrieved content into the note.

### BACKGROUND

Note applications incorporate various writing assistance tools to facilitate and support users in their writing compositions. One common writing assistance tool includes proofing capabilities that automatically, or in response to a user's directive, check a writing composition to recommend spelling, grammar, and stylistic changes. More recent tools involve the use of machine learning. Some note applications incorporate chatbots powered by artificial intelligence (AI) to provide powerful functionalities in response to natural language input. Another class of tools involves the use of generative AI models that generate entire writing compositions in response to a user-provided prompt.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Implementations for providing automated insights in note applications are provided. One example includes a computing system for providing automated insights in a note application, the computing system comprising: processing circuitry and memory storing instructions that, during execution, causes the processing circuitry to: analyze content of a note in real-time in the note application using a large language model (LLM), wherein the LLM identifies content search query with retrieval-augmented generation (RAG) in a database; retrieve content from the database; summarize the retrieved content from the database using the LLM; display the summarized retrieved content in real-time in the note application; and upon receiving input from a user to incorporate the summarized retrieved content, incorporate the summarized retrieved content into the note.

### BRIEF DESCRIPTION OF THE DRAWINGS

FIG. 1 shows a schematic view of an example computing system for implementing a note application with automated insights.

FIG. 2 shows a data flow diagram of an example method for providing automated insights in a note application, which can be implemented using the example computing system of FIG. 1.

FIG. 3 shows a user interface of an example note application capable of providing automated insights, which can be implemented using the example computing system of FIG. 1.

FIG. 4 shows a process flow diagram of an example method for providing automated insights in note applications, which can be implemented using the example computing system of FIG. 1.

FIG. 5 shows a schematic view of an example computing environment in which the computer system of FIG. 1 may be enacted.

### DETAILED DESCRIPTION

Note applications provide powerful tools for writing and editing. Writers and users of these applications often start their writing with only initial notes, brief points, and/or abstract ideas. Building out and supplementing these concepts typically involve extensive manual searches through various documents, messages, the internet, and other sources. The availability of information is usually not an issue. Conversely, there is often too much information such that it presents a challenge in searching for, filtering, and organizing information into something that can be incorporated into writing content. For example, users can spend a significant portion of the writing process searching for related information to add to their writing content, which typically involves looking through notes, messages, documents, and external sources. This process can be time-consuming and inefficient as the user needs to determine what to search for, how to search for it, probe through results, and pore over information to refine their ideas. Another issue involves writing processes where the writer takes multiple breaks between writing sessions. Starting again from an unfinished writing composition can be difficult as the user can forget relevant information and content from their previous stopping point.

Various solutions have been proposed to help users find relevant content. One class of solutions involves the user of AI chatbots incorporated in note applications that enable users to find information using natural language input. Generally, these chatbots interface with backend large language models (LLMs) linked with functionalities to address the various needs of the users. However, such solutions still require the user to proactively ask the chatbot (e.g., supply the LLM query) to perform the desired task(s), which can result in poor results due to lack of expertise and/or experience in prompt engineering. In many cases, the users are not aware of the capabilities of such tools and avoid their use entirely.

In view of the observations above, techniques for providing automated insights in note applications are provided. The present disclosure provides implementations of an AI-powered automated insight application that proactively finds related content and presents insights to users during the writing process. Insights refer to information related to a content of interest. For example, insights can include relevant information to content that the user is currently viewing in the user interface of a note application. Insights can be presented in various ways, including being presented as an informative summary/analysis and/or as a recommendation. The automated insight application can function proactively by taking advantage of machine learning techniques and LLM architectures to reason and determine what a user might need. Coupled with backend insight data providers, the automated insight application is capable of generating and presenting insights with relevant content to the user.

Briefly, the automated insight application provides insights by first analyzing content of a note in real-time in the note application using an LLM. For example, the application can detect a current viewing window of the note application, which indicates the content on which the user is currently focused or writing. The current viewing window can be text of the current writing or other media content that is viewable by the user (e.g., text currently displayed in the user interface). In some note applications, the document is organized into pages. For example, a note application can organize a project by pages that can be navigated through tabs and links. In such cases, the current viewing window can be a page that is currently being displayed in the user interface. In some implementations, contextual data is analyzed. Contextual data, such as content in the current viewing window, content in nearby pages, etc., can be used to generate insights. Contextual data can also include metadata describing actions and the behavior of a user (e.g., switching between pages). In some implementations, the analyzed content and/or contextual data is utilized by the LLM to identify content search query with retrieval-augmented generation (RAG) in a database. The automated insight application transmits the contextual data along with requests to insight data providers, and content from the database is retrieved. The retrieved content can be filtered/summarized for relevancy and likelihood of being applicable to the user's writing. Generally, the filtered results are formatted and rendered as insights to the user in a non-conspicuous manner so as to avoid interfering with the user's writing process. In some implementations, the rendered insights include one or more recommendations to incorporate the retrieved content. Upon receiving input from a user to incorporate such content, the content is incorporated into the note.

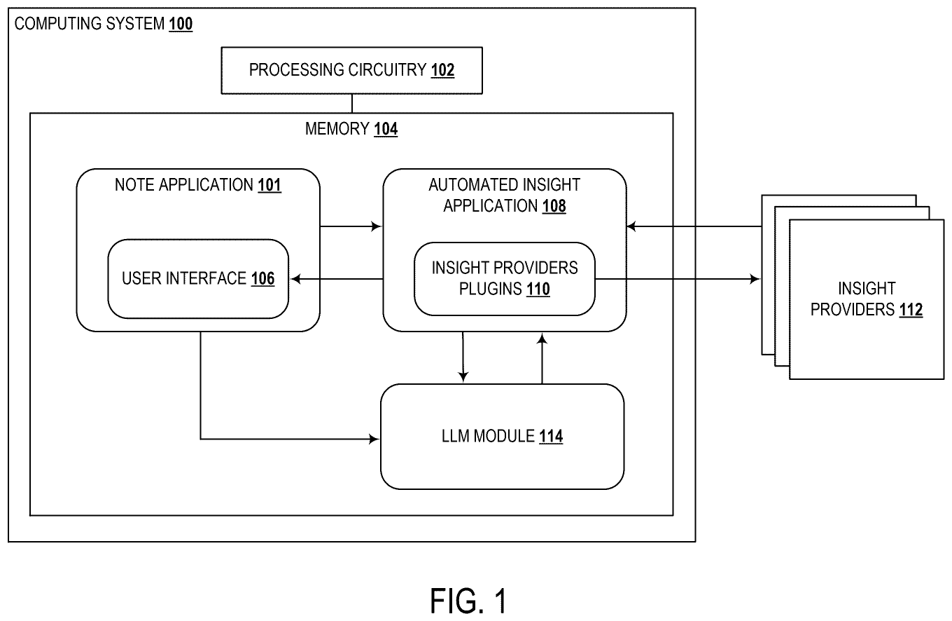

Turning now to the drawings, techniques for providing automated insights in note applications are depicted and described in further detail. FIG. 1 shows a schematic view of an example computing system 100 for implementing a note application 101 with automated insights. The example computing system 100 includes processing circuitry 102 and memory 104 storing instructions that, during execution, cause the processing circuitry 102 to perform the processes described herein. The example computing system 100 can be implemented with one or more of various types of computing devices, including but not limited to personal computers, servers, and mobile devices. For example, the computing system 100 can include a plurality of computing devices, and processing circuitry 102 and memory 104 may each include multiple components spread across multiple computing devices (e.g., processing circuitry 102 can include multiple processors within a single device or spread across multiple devices). The devices may be locally and/or remotely located. The example computing system 100 can also include non-depicted components for providing various functionalities, including components on individual computing devices.

The note application 101 provides a writing tool for users to write and edit text compositions through a user interface 106. Various types of note applications can be implemented. In some implementations, the notes within the note application 101 are organized in hierarchical pages, sections, and notebooks that can be easily rearranged. The note application 101 operates in tandem with an automated insight application 108 configured for generating and rendering insights in the user interface 106 of the note application 101.

The automated insight application 108 can seamlessly integrate with a user's workflow, presenting insights proactively by automatically gathering related data and suggesting actions in the background without the user's input. By offloading the process of searching and gathering information to an automated process, significant time savings and convenience can be provided to the writing process for the user. Data and related recommendations can be presented as insights while the user is writing, allowing them to stay productive without having to manually search or ask for related content. The automated insight application 108 can proactively pull related documents, communications, notes, and other content, allowing a user to quickly review and integrate information into their work without having to change their existing habits of how they work. Such implementations can enhance efficiency by delivering relevant information from both internal and external sources (e.g., local documents, internet search, etc.) as a supplement alongside the user's current writing.

The automated insight application 108 can generate and render insights in various ways. Generally, insights can be generated based on a user's current state in the writing process. In some implementations, the automated insight application 108 directs an LLM module 114 to analyze content within a note in which a user is currently writing. The content can be analyzed in real-time, and the LLM identifies content search query with retrieval-augmented generation (RAG) in a database. For example, the automated insight application 108 can generate insights by analyzing content within a note based on a current viewing window in the user interface 106 of the note application 101. In some implementations, contextual data based on the current viewing window can be used as input for the generation of insights. Contextual data can include various aspects of the current state of the user's writing session. In some implementations, the contextual data includes at least content in the current viewing window. For example, the contextual data can include text in a current active page. Additionally or alternatively, the contextual data can include currently non-viewable content, such as content in nearby pages and/or the entire document. In some implementations, the contextual data includes metadata. For example, the contextual data can include metadata such as information describing the user's viewing actions, such as a recently viewed page, a frequently viewed page, etc. Furthermore, the contextual data can include content from such pages.

In some implementations, the contextual data includes user settings and preferences. After usage of the automated insight application 108 over time, a user can develop or configure settings and preferences to tailor the insight experience. User preferences can be manually or automatically configured. For example, users can specify if they do not want a specific insight component type to be presented. In some implementations, the automated insight application 108 tracks the usage of the presented insights over time. Insights containing recommendation can be monitored to determine if the user ultimately takes the recommendation. Information regarding whether the user does or does not take the recommendation can be used to tailor future insight generation. Recommendations that are often successful can be shown more frequently, and recommendations that are less taken can be shown less frequently. In some implementations, a user can provide feedback to the automated insight application 108. The feedback can be utilized to select insight providers that are more likely to provide relevant results. As the automated insight application 108 is refined over time, more relevant insights can be provided. This refinement can be implemented in automated insight applications globally and/or implemented just for the respective user.

Generation of insights using contextual data can be performed in various ways. In the depicted example, the automated insight application 108 implements a plurality of plug-ins 110 for respective insight providers 112. An insight provider 112 is an entity capable of generating an insight component to be included in insights presented to the user. In some implementations, the insight providers 112 include an external entity performing an external service. For example, an insight provider can be called upon to perform an internet search for related content. An insight provider can also be a local entity, such as a program utilizing a locally-located LLM to generate content to be included in the insights presented to the user.

The plug-ins 110 can be implemented to send requests along with the analyzed content and/or contextual data to respective insight providers 112. Any number and type of insight providers 112 can be called upon. In some implementations, the automated insight application 108 calls upon a predetermined number of insight providers 112. For example, the automated insight application 108 can store a list of insight providers, which can be altered over time. In some implementations, the automated insight application 108 performs calls to every insight provider on the list. In other implementations, the automated insight application 108 performs calls to a portion of the list. In the depicted example, the automated insight application 108 utilizes the LLM module 114 to select the insight providers 112 to be invoked. The insight providers 112 can be selected based on various criteria. For example, the LLM module 114 can utilize an LLM trained to determine relevant insight providers based on input contextual data.

Upon selecting the relevant insight providers, the automated insight application 108 transmits the corresponding requests along with the contextual data. The insight providers 112 then perform their data collection/analysis/synthesis, and content is returned to the automated insight application. In some implementations, one or more of the insight providers 112 perform search queries for content with RAG patterns from one or more database. In some implementations, the retrieved content from the insight providers 112 is filtered/summarized to determine summarized content that can be presented to the user as insights. Summarized content can be determined in various ways. For example, the summarized content can be determined using the LLM module 114, which includes one or more LLMs. In some implementations, a single LLM is used to determine both which insight providers to utilize and which received results are relevant. In other implementations, a first LLM is implemented to determine which insight providers to call upon based on the contextual data, and a second LLM is implemented to determine which retrieved content from the insight providers are relevant and should be included in the summarized content.

Once the summarized content is determined, they can be rendered to the user interface 106 of the note application 101 for the user to view. The summarized content can be insights that include various insight components, each component including content from a respective insight provider 112. In some implementations, each insight provider is associated with one or more visualization patterns that can be used for rendering the related results. For example, an insight provider capable of performing an internet search to retrieve related articles may be associated with one or more visualization patterns for presenting data related to the retrieved articles. An example visualization pattern can include presenting a link and/or a summary of the article. Any format of visualization patterns can be implemented. Further details and examples of insight providers are described in the sections below.

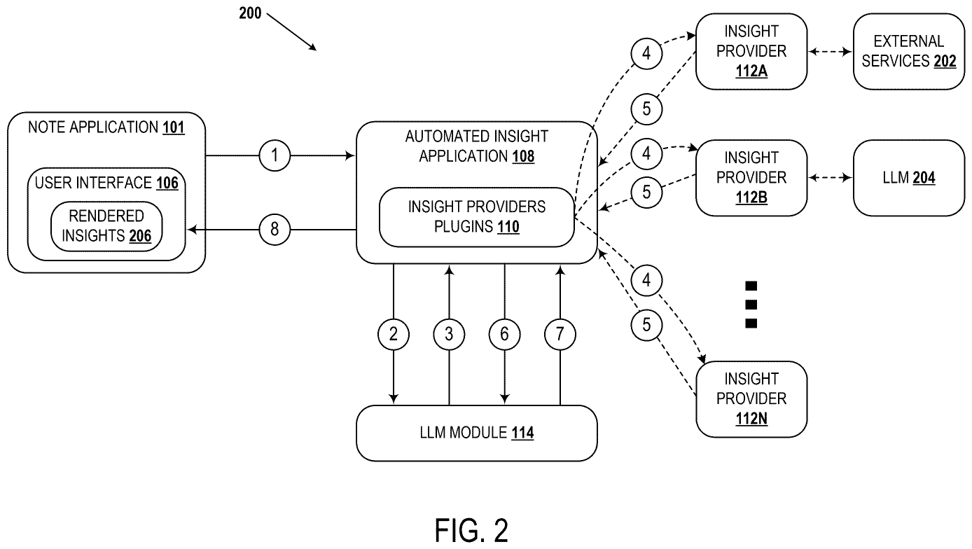

FIG. 2 shows a data flow diagram of an example method 200 for providing automated insights in a note application 101. The workflow process 200 can utilize content understanding paired with RAG patterns to source relevant information through insight data providers 112. Such information can be developed by an LLM module 114 into content that is relevant to the user's writing. The process 200 can present relevant content to an existing document without requiring a user to provide search queries or ask the system to provide content. The workflow process 200 starts at a first step where content of a note in a note application 101 is analyzed, which can optionally include contextual data. In some implementations, the analyzed content and/or contextual data is based on a current viewing window. The content and/or contextual data can be analyzed in real-time by an LLM module 114. For example, the automated insights application 108 can perform its workflow in response to a page load event and/or a page navigation event. Users opening the note application 101 to an incomplete project can cause a page load event, which triggers the automated insight application 108 to perform its workflow. Insights may provide a refresher on the topic as users may forget some aspects since their last writing session on said project. Users switching between pages can cause a page navigation event that triggers the automated insight application 108 to perform its workflow. As users navigate their writing in the user interface 106 of the note application 101, the automated insight application 108 can update the rendered insights automatically. In some implementations, the automated insight application 108 performs its workflow in response to changes in the content of the writing (e.g., as the user continues to write). In some implementations, the automated insight application 108 performs its workflow at predetermined time intervals.

At a second step, the workflow process 200 includes the automated insight application 108 querying the LLM module 114 to determine a list of insight providers to utilize based on inbound information. For example, information such as contextual data and other relevant information including but not limited to user preferences and previous feedback can be utilized. In some implementations, information such as preferences and previous feedback can be stored in an external system and engaged by the automated insight application 108. The LLM module 114 can be implemented with one or more LLMs configured to determine the list of insight providers to call upon. Various criteria can be utilized. Generally, the contextual data provides information on which insight provider can likely provide relevant data. The LLM module 114 can be implemented in various ways with LLMs of different architectures.

At a third step, the LLM module 114 returns a list of insight providers to invoke. Invoking the insight providers, at the fourth step, can be performed in various ways. In the depicted example, the automated insight application 108 includes insight providers plug-ins 110 for invoking the insight providers 112. As shown, calls to each of the insight providers 112A-112N are optional and can be dependent on the list of insight providers selected by the LLM module 114.

At a fifth step, the insight providers 112 called upon collects data and return content to the automated insight application 108. The insight providers 112 can collect data in various ways. One way involves calling other systems to collect data. In some implementations, the insight providers 112 collects data using a RAG pattern, engaging with various other systems and searching for related content. In the depicted example, insight provider 112A engages external services 202 to collect data. For example, an insight provider 112 can perform internet searches to collect data. A more localized search can also be utilized. In some implementations, a search on the local computing system can be performed by an insight provider 112. Local documents, contacts information, etc. can be utilized to provide insights. An insight provider 112 can also engage a database to collect data. For example, providers of database solutions, including cloud storage solutions, may provide their tenants, or users, with access to their corresponding databases. The automated insight application 108 may be linked and granted permission to a given database associated with a user of the note application 101. In such cases, an insight provider 112 can query and access data associated with the user to provide insights. In some implementations, one or more insight providers 112 engage LLM(s) 204 to generate content that can be returned to the automated insight application 108. In the depicted example, insight provider 112B engages with an LLM 204 to generate content. As can readily be appreciated, the logic of each insight provider 112 can vary and can involve utilization of various components. For example, an insight provider 112 can first engage external services 202 first, then query an LLM 204, and then engages external services 202 again.

To provide an insight experience that is non-obtrusive to the user, the retrieved content can be summarized and filtered such that only a predetermined number or display size of insights are shown to the user. At a sixth step, the automated insight application 108 analyzes the retrieved content from the insight providers 112 to determine summarized content that can be rendered and presented to the user. The summarized content can be determined in various ways. In some implementations, the retrieved content includes a plurality of insight components that are ranked based on relevancy, and a predetermined number of the highest ranked results are included in the summarized content. The ranking can be performed in various ways. Information such as user settings, user preferences, previous feedback, display size, etc. can be used to determine relevancy. In some implementations, internal logic is applied to the received results for prioritization. For example, a summary of the note can be prioritized when contextual data indicates that the user is opening an unfinished document. Another example includes prioritizing the changes in the document since the user last opened it if a different user has since made changes. In the depicted example, the summarized content is determined using at least the LLM module 114, and the summarized content is returned to the automated insight application 108 at a seventh step. The LLM module 114 can utilize the same or different LLMs for determining the list of insight providers to invoke and for determining the summarized content. In some implementations, the list of insight providers that were called upon is selected to be a small set of insight providers such that the entirety of the returned results can be formatted for visualization and displayed to the user without obstructing the user's writing process. In such cases, the step of determining summarized content can be omitted.

At an eight step, the workflow process 200 includes presenting the summarized content to the user through the user interface of the note application. The summarized content can be formatted and rendered as insights 206 in an insight window that is placed in a non-obtrusive manner, such as in a peripheral area of the user interface 106. The insights 206 can be rendered in various ways. In some implementations, the insights 206 are made of individual insight components, each of which correspond to a respective insight provider 112. Different insight components can be rendered differently. In some implementation, each type of insight component and/or insight provider is associated with multiple visualization patterns. For each insight component, a visualization pattern is selected, and the insights are rendered accordingly. For example, some insight components can be rendered as a body of text. Some insight components can include a large amount of text and are rendered as a shortened preview form of content. Any visualization pattern and layout can be implemented. In some implementations, the insight component includes a recommendation for the user to take, rendered in the form of an interactable control element (e.g., a button).

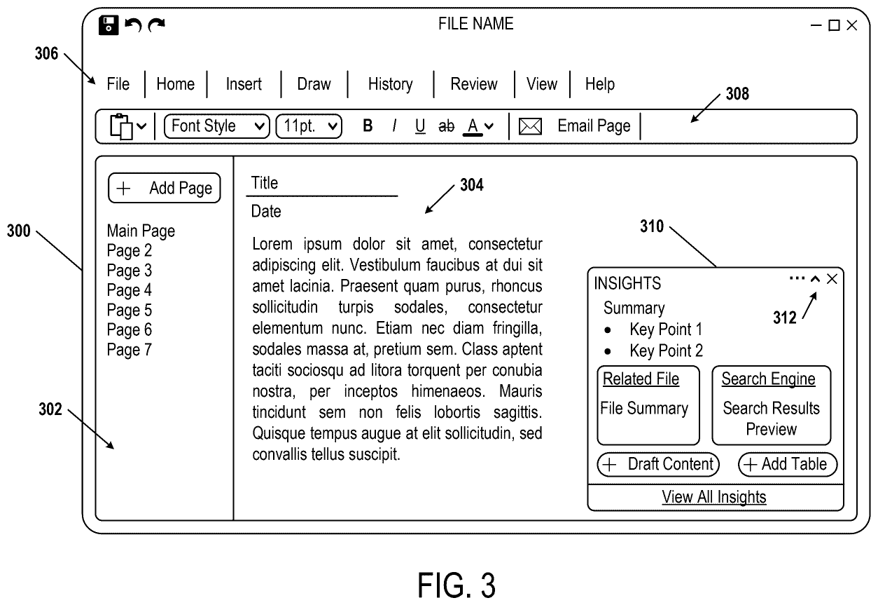

FIG. 3 shows a user interface 300 of an example note application capable of providing automated insights. In the depicted example, the note application is a writing editor where the document, or notebook, is organized by pages. As shown, the user interface 300 includes a page navigation pane 302 where users can quickly switch between pages and a main pane 304 where the writing takes place. The user interface 300 further includes menus 306 for navigating through options and tools and a ribbon pane 308 that includes various functionalities such as formatting options. In its current state, the user interface 300 of FIG. 3 depicts an insight window 310 that is opened, displaying insights for the user to view. Generally, the insight window 310 is advantageously placed in the user interface 300 in an inconspicuous location such that it does not visually hinder the user during the writing process. In the depicted example, the insight window/pane 310 is located at the bottom right of the user interface 300.

The insight window 310 can be configured and displayed in various ways. For example, the insight window 310 can be designed to be as non-obtrusive as possible to the user's writing experience. In some implementations, the insight window 310 is a movable window. The insight window 310 can include the ability for users to dismiss the insights if they do not wish to see it. In some implementations, the insight window 310 disappears upon dismissal and reappears if the user opens the page again (or any other type of heuristic). On the other hand, the user interface 300 can include an ability for users to engage the insight window 310 if it is not currently showing. In the depicted example, the insight window 310 includes interactable icons 312 for showing more options, minimizing and expanding the insight window, and closing the insight window. In some implementations, the insight window 310 is initially presented in an unexpanded format, and the user can decide on whether to expand the window to view and interact with the insights. The insight window 310 can be implemented with various sizes, trading off visual clutter for the amount of information displayed. In the depicted example, the insight window 310 includes several insight components that are visualized in different forms and formats, including text summaries, internal document links, external search links, and recommendation buttons. The insight window 310 further includes an interactable option that shows all insights, including non-rendered insights.

Generally, the insight window 310 is shown/refreshed upon a page load event and/or a page navigation event. Users can see refreshed information in the insight window 310 as they navigate pages, wherein the refreshed information is relevant to the currently opened page at the time. In some implementations, the insight window 310 can be refreshed manually. For example, the insight experience can be configured to refresh (or not) while the user is writing. If the insights have not been refreshed, the ability to manually refresh the insight window 310 can be advantageously implemented.

Insights can include various types of insight components. Different insights and insight components can be provided depending on the content of the current page. One example of an insight component includes an informative summary. The informative summary can be a summary (e.g., in paragraph or bullet form) of a local or external document. The summary can also be for different portions, or the entirety, of the currently opened document. For example, the informative summary can be a summary of the current page (e.g., if the current page is past a certain length), another page, or the entire document. In some implementations, new pages (e.g., pages shared by other users) can be summarized. In some implementations, other pages deemed related to the current page can be summarized.

Another example insight component includes showing a related file, such as a document, spreadsheet, slide deck, etc. The file can be related to the current page or the entire document. Related e-mails and messages (e.g., from a messaging application) can also be shown to the user. Another example insight component includes information related to related people, such as contact information. Another example insight component includes backlinks, which are links to pages that link to the current page. Another example insight component includes an overview of changes since the user's last session of the note application. For example, in collaborative project, many different users may have access to the same document. A note application with the user's settings may remember the document's state after the user's last session. Differences can be determined, summarized, and presented as an insight component. Another example insight component includes a suggestion to perform various formatting changes to the current page, correct spelling, correct grammar, etc. Another example insight component includes a suggestion to generate content based on the content of the current page. For example, the insight component can include a suggestion to take content of the current page to generate an email, a slide deck, or any other document.

The automated nature of the insight experience enables the possibility of eliminating search time for certain information, saving valuable time for the user. Even if the automated insight application does not provide information that can be used by the user, there is still little impact to the user's productivity as the application can be presented in an inconspicuous manner. In cases where the insight application returns incomplete results, the user can prompt the insight application to further refine the results, which can still provide valuable time savings. In some implementations, the insight window 310 can include insights that could be further engaged with in natural language via chat. For example, a suggested document can have the ability for a user to click to engage chat.

Components can be visualized in engaging ways, helping users to find value in the information while providing the ability to include the information in their content and/or search further. Each component can have multiple variations for how visualization of the content is provided. For example, the summaries can be provided in paragraph form or in bullets. Suggested documents can be provided as a list of documents or extracted key information. Determining which variation to use can be performed in various ways. In some implementations, an LLM is used to determine the visualization patterns of the insight components.

Some content might be initially truncated, so it does not obstruct the user's view while writing and/or does not take up a large portion of the insight window 310. In some implementations, the automated insight application tracks whether users expand the truncated content and/or how long the user leaves the content expanded (e.g., dwell time). Such information can be used to further tailor future insight workflows. Some content might be synthesized or summarized by an LLM. Existing citation models can be used to show related or referenced information that the user can follow to learn more, or general links to related information can be used to help users open other documents or content in or outside of the note application.

In some implementations, the application provides for receiving feedback from the users. For insights that can be read and provide value without further action (e.g., insertion) but do not have an expansion capability, it can be difficult to track performance for use in refining the application (e.g., machine learning). In some implementations, the insight experience provides an ability for the user to provide feedback, such as a button for signaling positive or negative feedback to the system. The system can also be manually configured to the user's preferences through configuration settings that control what type and/or category of insights are shown. Through usage and machine teaching techniques, the insight application can be tuned both globally to provide all users with relevant information as well as personally-tuned to the type and style of information that a user prefers.

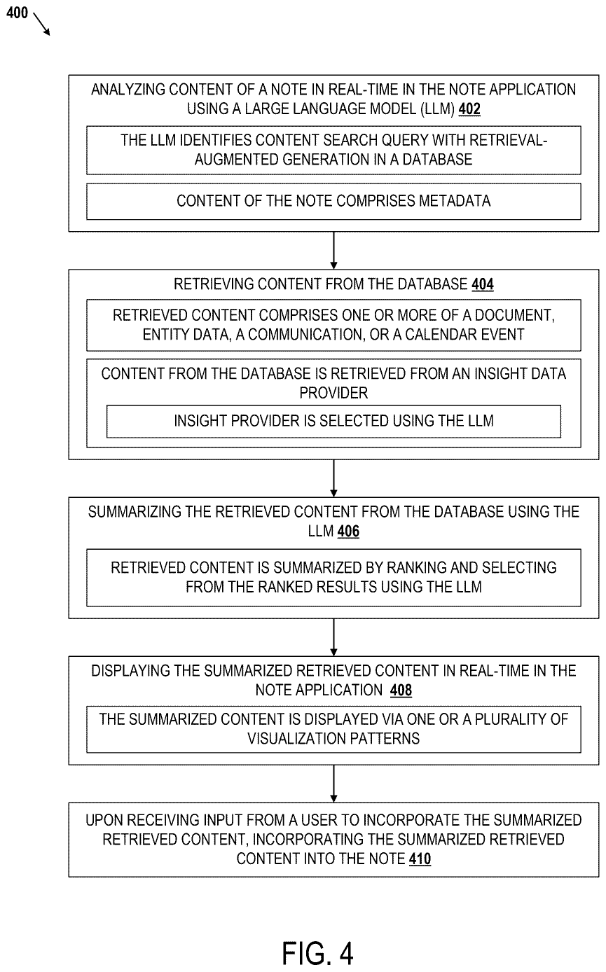

FIG. 4 shows a process flow diagram of an example method 400 for providing automated insights in note applications. The example method 400 includes, at step 402, analyzing content of a note in real-time in the note application using a large language model. Any type of note application can be utilized. In some implementations, the note application provides an organizational scheme that includes the ability to create pages and appropriate navigation tools. The content of the note can include various types of data, including text, content, and contextual data. In some implementations, the content of the note to be analyzed includes metadata. The LLM utilizes the content of the note to identify content search queries with retrieval-augmented generation in a database.

In some implementations, the content of the note to be analyzed is determined by detecting a current viewing window. Detecting the current viewing window can include detection of various changes in the note application. In some implementations, detecting the current viewing window includes detecting changes to content in the current writing composition. For example, as a user continues to write and add content, the automated insight application is updated in real-time to provide more relevant insights. Insights refer to information related to a content of interest. For example, insights can include relevant data to a user's current writing composition that is currently loaded/opened in the note application. Providing the insights can be implemented in various ways. In some implementations, the insights are generated and rendered to the user based on various aspects, including but not limited to the current viewing window and content within the current viewing window. In some implementations, detecting the current viewing window includes detecting a change to a more current viewing window. This can include, for example, detecting a scrolling event to a different portion of the current page and/or detecting a page load event when the user switches to a different page.

Contextual data can be gathered in various ways. In some implementations, a machine learning model is applied to determine contextual data. For example, content from various portions of the current writing composition can be provided as input to a machine learning model trained to determine relevant data. Contextual data for the current viewing window can be based on various aspects. Generally, the contextual data for the current viewing window includes at least the content currently viewable through the user interface. Additionally or alternatively, the contextual data can include content that is currently non-viewable. For example, the contextual data can include content on a different page (e.g., nearby pages, recently viewed pages, relevant pages determined through a machine learning model, or the entire document) or content on the current page but non-viewable (e.g., content above or below the current view of the page). In some implementations, the contextual data includes information describing the user's viewing actions, which can be used to predict the user's intent. Such information can include but is not limited to information describing one or more historical viewing windows, information describing a viewing pattern (e.g., if the user constantly switches between two pages, such pages can be included in the contextual data), and/or information describing user preferences.

At step 404, the example method 400 includes retrieving content from the database. Various types of content can be retrieved. In some implementations, the retrieved content includes one or more of a document, entity data (e.g., contact information, name, number, email address, etc.), a communication (e.g., emails, letters, etc.), or a calendar event. The content can be retrieved from various sources. In some implementations, the content from the database is retrieved from an insight data provider. For example, a request can be transmitted by the automated insight application to an insight provider. The insight provider can be selected in various ways, including but not limited to the use of the LLM. In some implementations, a plurality of requests is transmitted to a plurality of respective insight providers.

Transmitting the plurality of requests can be performed in various ways. In some implementations, transmitting the plurality of requests includes running plug-ins configured in the note application, each of the plug-ins configured to call upon a respective insight provider of the plurality of insight providers. An insight provider is an entity capable of generating an insight component. Generally, the requests are accompanied by the contextual data. Different insight provider can utilize the contextual data in different ways to generate insight components. In some implementations, at least one of the plurality of insight providers utilizes a large language model to generate content based on the contextual data. For example, a large language model can be tasked with summarizing and condensing the contextual data into a form that is easier for the user to peruse. In some implementations, at least one of the plurality of insight providers utilizes an external source and/or external database to generate content. For example, an insight provider can perform an internet search based on a given topic derived from the contextual data.

The plurality of insight providers can be selected in various ways. In some implementations, the automated insight application includes a set list of insight providers, which can be altered over time. Requests can be transmitted to each of these insight providers. In some implementations, the plurality of insight providers is selected from the set list. In further implementations, the plurality of insight providers is selected using a large language model and the contextual data. A large language model can be trained and utilized to determine which insight providers, from a set list of insight providers, are relevant and/or likely to provide relevant data. For example, if the contextual data includes numerical values associated with different headings, an insight provider capable of formatting such data into charts and graphs can be selected. If the contextual data contains content from other pages relevant to the current viewed page, an insight provider capable of summarizing the content from the other pages (e.g., using a large language model) can be selected.

In some implementations, user preferences are utilized to determine which insight provider(s) to utilize. User preferences can be configured in various ways to provide customized and tailored insights. User preferences can be manually or automatically configured. For example, users can configure settings such that a particular insight provider is always or never utilized. In some implementations, a user can provide feedback to the automated insight provider. The positive/negative feedback can be utilized to select insight providers that are more likely to provide relevant results. Such feedback can be used to customize an experience for the individual user. In some implementations, feedback from users is utilized to customize the application globally, affecting all connected applications. The automated insight application can also monitor users' actions to provide tailored insights without the users' input. For example, insights that include recommendations can be monitored for whether users take or not take the recommended action. Recommendations that are often successful can be shown more frequently (e.g., the corresponding insight provider can be called upon more often).

At step 406, the method 400 includes summarizing the retrieved content from the database. The retrieved content can be summarized in various ways. In some implementations, the retrieved content is summarized using the LLM. The content can be summarized into summarized content that can be displayed to the user, removing excess clutter. In some implementations, the retrieved content are ranked, and the highest ranked results are selected to be included in the summarized content. A predetermined number of results can be selected. Any type of ranking criteria can be utilized. In some implementations, the retrieved content are ranked based at least upon prior user usage. For example, insight components that are more engaging in previous sessions can be ranked higher. In some implementations, a large language model is utilized to determine the summarized content from the retrieved content. For example, a large language model can be trained to rank and select retrieved content that is predicted to be relevant to the user. The large language model can be the same or a different one from the large language model used to select the plurality of insight providers (if one was used).

At step 408, the method 400 includes displaying the summarized retrieved content to the user. The summarized content can be displayed and updated in real-time in the note application as the user writes. The summarized content can be displayed in various ways. Generally, the summarized content can be rendered as insights made of at least one insight component and displayed to the user through an insight window. The insight window can be displayed in a peripheral area of the user interface of the note application so as to not interfere with the user's writing session. In some implementations, the insight window is implemented with various interactable control elements that allow the user to perform actions such as minimize, expand, close, etc. Different insight components can be rendered differently. In some implementation, each type of insight component and/or insight provider is associated with multiple visualization patterns. For each piece of the summarized content, an appropriate visualization pattern can be selected to perform rendering. For example, some insight components can be rendered as a body of text, which may include a heading, a link, an image, etc. Some insight components can include a large amount of content and are initially presented as a preview window of text that can be expanded or linked to the full text. Any visualization pattern and layout can be implemented.

At step 410, the method 400 includes incorporating the summarized retrieved content into the note. The content can be incorporated upon receiving an indication from the user. In some implementations, the insight component includes a recommendation for the user to take. For such cases, the rendering can include rendering an interactable button that, when clicked by the user, performs the recommended action (e.g., generating text content, creating a graph, importing content, etc.). Any other interactable control element can be utilized.

Steps 402-410 describe an example set of steps for generating and providing insights to a user upon detecting a current viewing window in the user interface of the note application. As the user continues to write in real-time, the example method 400 of providing insights can be concurrently performed to provided updated insights in real-time. For example, upon detecting a change in the current viewing window, the example method 400 can be performed to provide updated insights based on the new current viewing window. The detected change can include any of the detected aspects of the user interface. For example, a detected change in the current viewing window can include detecting a scrolling event, a switch to a different page, or changes to the content of the writing composition (e.g., as the user continues to write and add more content). In some implementations, the example method 400 is performed periodically, detecting the current viewing window and updating the provided insights accordingly based on time intervals.

In some embodiments, the methods and processes described herein may be tied to a computing system of one or more computing devices. In particular, such methods and processes may be implemented as a computer-application program or service, an application-programming interface (API), a library, and/or other computer-program product.

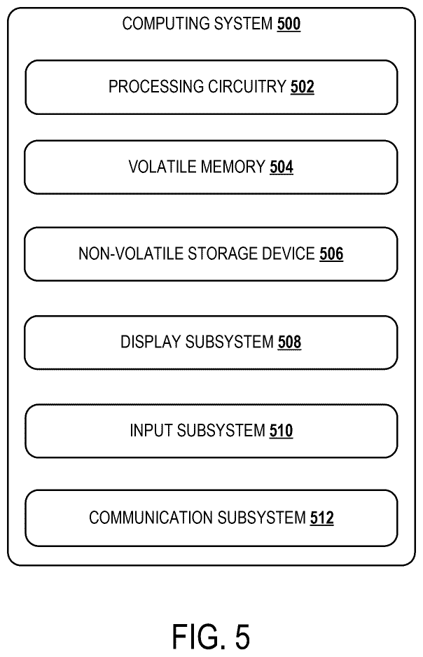

FIG. 5 schematically shows a non-limiting embodiment of a computing system 500 that can enact one or more of the methods and processes described above. Computing system 500 is shown in simplified form. Computing system 500 may embody the computing system 100 described above and illustrated in FIG. 5. Components of computing system 500 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 500 includes processing circuitry 502, volatile memory 504, and a non-volatile storage device 506. Computing system 500 may optionally include a display subsystem 508, input subsystem 510, communication subsystem 512, and/or other components not shown in FIG. 5.

Processing circuitry 502 includes a logic processor that can be implemented with one or more physical devices configured to execute instructions. For example, the processing circuitry 502 may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The processing circuitry 502 may include one or more physical processors configured to execute software instructions. Additionally or alternatively, the processing circuitry 502 may include one or more hardware logic circuits or firmware devices configured to execute hardware-implemented logic or firmware instructions. Processors of the processing circuitry 502 may be single-core or multi-core, and the instructions executed thereon may be configured for sequential, parallel, and/or distributed processing. Individual components of the processing circuitry 502 optionally may be distributed among two or more separate devices, which may be remotely located and/or configured for coordinated processing. Aspects of the processing circuitry 502 may be virtualized and executed by remotely accessible, networked computing devices configured in a cloud-computing configuration. In such a case, these virtualized aspects are run on different physical logic processors of various different machines, it will be understood.

Non-volatile storage device 506 includes one or more physical devices configured to hold instructions executable by the processing circuitry 502 to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by processing circuitry 502 to temporarily store information during processing of software instructions. It will be appreciated that volatile memory 504 typically does not continue to store instructions when power is cut to the volatile memory 504.

Aspects of processing circuitry 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via processing circuitry 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with processing circuitry 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, camera, or microphone.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 500 to send and/or receive messages to and/or from other devices via a network such as the Internet.

Further examples of providing automated insights in a note application are provided. One example includes a computing system comprising: processing circuitry and memory storing instructions that, during execution, causes the processing circuitry to: analyze content of a note in real-time in the note application using a large language model (LLM), wherein the LLM identifies content search query with retrieval-augmented generation (RAG) in a database; retrieve content from the database; summarize the retrieved content from the database using the LLM; display the summarized retrieved content in real-time in the note application; and upon receiving input from a user to incorporate the summarized retrieved content, incorporate the summarized retrieved content into the note. In this example, additionally or alternatively, the retrieved content comprises one or more of a document, entity data, a communication, or a calendar event. In this example, additionally or alternatively, the content of the note comprises one or more of: content in a current page; content from one or more nearby pages of the current page; information describing one or more historical viewed page; information describing a pattern in changes among the one or more historical viewed pages; content in the one or more historical viewed pages; or user preference settings. In this example, additionally or alternatively, the content of the note comprises non-viewable content in a current page. In this example, additionally or alternatively, the content from the database is retrieved from an insight data provider. In this example, additionally or alternatively, the insight data provider is selected using the LLM. In this example, additionally or alternatively, summarizing the retrieved content comprises: ranking the retrieved content using the LLM; and selecting a predetermined number of highest ranked results from the ranked retrieved content to be included in the summarized retrieved content. In this example, additionally or alternatively, the retrieved content is ranked based at least upon prior user usage. In this example, additionally or alternatively, retrieving the content from the database comprises running plug-ins configured in the note application, each of the plug-ins configured to call upon a respective insight provider. In this example, additionally or alternatively, the content from the database comprises LLM-generated content.

Another example includes a method comprising: analyzing content of a note in real-time in the note application using a large language model (LLM), wherein the LLM identifies content search query with retrieval-augmented generation (RAG) in a database; retrieving content from the database; summarizing the retrieved content from the database using the LLM; displaying the summarized retrieved content in real-time in the note application; and upon receiving input from a user to incorporate the summarized retrieved content, incorporating the summarized retrieved content into the note. In this example, additionally or alternatively, the retrieved content comprises one or more of a document, entity data, a communication, or a calendar event. In this example, additionally or alternatively, the content of the note comprises one or more of: content in a current page; content from one or more nearby pages of the current page; information describing one or more historical viewed pages; information describing a pattern in changes among the one or more historical viewed pages; content in the one or more historical viewed pages; or user preference settings. In this example, additionally or alternatively, the content from the database is retrieved from an insight data provider. In this example, additionally or alternatively, the insight data provider is selected using the LLM.

Another example provides a method comprising: analyzing content of a note in real-time in the note application using a large language model (LLM), wherein the LLM identifies content search query with retrieval-augmented generation (RAG) in a database; performing a plurality of calls to a plurality of respective insight data providers; retrieving content from the database, wherein the retrieved content comprises a plurality of insight components provided by the plurality of respective insight data providers; summarizing the retrieved content from the database by selecting a subset of the plurality of insight components to display; for each of the subset of the plurality of insight components to display, selecting a visualization pattern; displaying the subset of the plurality of insight components in real-time in the note application based at least upon the selected visualization patterns; and upon receiving input from a user to incorporate one or more of the displayed subset of the plurality of insight components, incorporating the one or more of the displayed subset of the plurality of insight components into the note. In this example, additionally or alternatively, the plurality of respective insight data providers is selected using the LLM based at least upon the analyzed content of the note. In this example, additionally or alternatively, the subset of the plurality of insight components to display is selected using the LLM. In this example, additionally or alternatively, the input received from the user to incorporate the one or more of the displayed subset of the plurality of insight components comprises an indication of the user interacting with at least one interactable control element displayed in the note application. In this example, additionally or alternatively, incorporating the one or more of the displayed subset of the plurality of insight components into the note comprises importing a data visualization element.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for providing automated insights in a note application, the computing system comprising:
processing circuitry and memory storing instructions that, during execution, causes the processing circuitry to:
analyze content of a note in real-time in the note application using a large language model (LLM), wherein the LLM identifies content search query with retrieval-augmented generation (RAG) in a database;
retrieve content from the database;
summarize the retrieved content from the database using the LLM;
display the summarized retrieved content in real-time in the note application; and
upon receiving input from a user to incorporate the summarized retrieved content, incorporate the summarized retrieved content into the note.

2. The computing system of claim 1, wherein the retrieved content comprises one or more of a document, entity data, a communication, or a calendar event.

3. The computing system of claim 1, wherein the content of the note comprises one or more of:
content in a current page;
content from one or more nearby pages of the current page;
information describing one or more historical viewed page;
information describing a pattern in changes among the one or more historical viewed pages;
content in the one or more historical viewed pages; or
user preference settings.

4. The computing system of claim 1, wherein the content of the note comprises non-viewable content in a current page.

5. The computing system of claim 1, wherein the content from the database is retrieved from an insight data provider.

6. The computing system of claim 5, wherein the insight data provider is selected using the LLM.

7. The computing system of claim 1, wherein summarizing the retrieved content comprises:
ranking the retrieved content using the LLM; and
selecting a predetermined number of highest ranked results from the ranked retrieved content to be included in the summarized retrieved content.

8. The computing system of claim 7, wherein the retrieved content is ranked based at least upon prior user usage.

9. The computing system of claim 1, wherein retrieving the content from the database comprises running plug-ins configured in the note application, each of the plug-ins configured to call upon a respective insight provider.

10. The computing system of claim 1, wherein the content from the database comprises LLM-generated content.

11. A method for providing automated insights in a note application, the method comprising:
analyzing content of a note in real-time in the note application using a large language model (LLM), wherein the LLM identifies content search query with retrieval-augmented generation (RAG) in a database;
retrieving content from the database;
summarizing the retrieved content from the database using the LLM;
displaying the summarized retrieved content in real-time in the note application; and
upon receiving input from a user to incorporate the summarized retrieved content, incorporating the summarized retrieved content into the note.

12. The method of claim 11, wherein the retrieved content comprises one or more of a document, entity data, a communication, or a calendar event.

13. The method of claim 11, wherein the content of the note comprises one or more of:
content in a current page;
content from one or more nearby pages of the current page;
information describing one or more historical viewed pages;
information describing a pattern in changes among the one or more historical viewed pages;
content in the one or more historical viewed pages; or
user preference settings.

14. The method of claim 11, wherein the content from the database is retrieved from an insight data provider.

15. The method of claim 11, wherein the insight data provider is selected using the LLM.

16. A method for providing automated insights in a note application, the method comprising:
analyzing content of a note in real-time in the note application using a large language model (LLM), wherein the LLM identifies content search query with retrieval-augmented generation (RAG) in a database;
performing a plurality of calls to a plurality of respective insight data providers;
retrieving content from the database, wherein the retrieved content comprises a plurality of insight components provided by the plurality of respective insight data providers;
summarizing the retrieved content from the database by selecting a subset of the plurality of insight components to display;
for each of the subset of the plurality of insight components to display, selecting a visualization pattern;
displaying the subset of the plurality of insight components in real-time in the note application based at least upon the selected visualization patterns; and
upon receiving input from a user to incorporate one or more of the displayed subset of the plurality of insight components, incorporating the one or more of the displayed subset of the plurality of insight components into the note.

17. The method of claim 16, wherein the plurality of respective insight data providers is selected using the LLM based at least upon the analyzed content of the note.

18. The method of claim 16, wherein the subset of the plurality of insight components to display is selected using the LLM.

19. The method of claim 16, wherein the input received from the user to incorporate the one or more of the displayed subset of the plurality of insight components comprises an indication of the user interacting with at least one interactable control element displayed in the note application.

20. The method of claim 16, wherein incorporating the one or more of the displayed subset of the plurality of insight components into the note comprises importing a data visualization element.
